(19) United States
(12) Patent Application Publication
(10) Pub. No.: US 2003/0035020 A1
(43) Pub. Date: Feb. 20, 2003

(54) Position measurement system and method

(76) Inventors: Jorge Menendez, Barcelona (ES); Jose M. Rio Doval, Barcelona (ES); Miguel Angel Perez, Barcelona (ES)

Correspondence Address: LADAS & PARRY, Suite 2100, 5670 Wilshire Boulevard, Los Angeles, CA, 90036-5679, US

(21) Appl. No.: 10/206,790

(22) Filed: Jul. 26, 2002

(30) Foreign Application Priority Data
Jul. 30, 2001 (GB) 0118509.9

(51) Int. Cl. B41J 23/00

(52) U.S. Cl. 347/37

(57) ABSTRACT

A sensor system for determining a position relative to a codestrip comprising a plurality of graduations spaced apart in a first direction, said system comprising first and second sensors arranged to move substantially in said first direction relative to said graduations and to output signals corresponding to the detection of said graduations, said system further comprising a differential screw adapted to adjust the spacing between said first and second sensors substantially in said first direction such that the outputs of said first and second sensors may be brought into a selected phase relationship.

### FIELD OF THE INVENTION

The present invention relates generally to a position measurement system, particularly, although not exclusively, to a method and apparatus for determining the position of a printer carriage in ink jet printer devices.

### BACKGROUND OF THE INVENTION

Inkjet printer devices generally incorporate one or more inkjet cartridges, often called “pens”, which shoot drops of ink onto a page or sheet of print media. For instance, two earlier thermal ink ejection mechanisms are shown in U.S. Pat. Nos. 5,278,584 and 4,683,481, both assigned to the present assignee, Hewlett-Packard Company. The pens are usually mounted on a carriage, which is arranged to scan across a sheet of print media as the pens print a series of individual drops of ink on the print media forming a band or “swath” of an image, such as a picture, chart or text. The print media is subsequently moved relative to the carriage after a swath has been printed, so that a further swath may be printed adjacent to the earlier swath. By a repetition of this process, a complete printed page may be produced in an incremental manner.

In order to generate high quality printed output, it is necessary that the ink drops from the individual pens are accurately applied to the print media. This is made possible by accurately measuring the position of the carriage as it traverses the print media. This is generally achieved using an encoder strip or codestrip, which is arranged parallel to the scan direction of the carriage. Such a codestrip is usually made from a plastics material such as Mylar™, upon which a series of graduations or marks are recorded. The graduations, which may be recorded using a laser plotter, give rise to local variations in the optical properties of the codestrip.

An optical sensor mounted on the carriage, senses the optical variations in the codestrip as the carriage moves relative to it. The output of the sensor is used by a microprocessor associated with the printer device to generate position and speed information relating to the carriage. Sensors of this type also generate a second signal generally known as the “B” signal, which is 90 degrees out of phase with but otherwise similar to the first signal “A”. The presence of the second signal additionally allows the microprocessor to determine changes in the direction of travel of the carriage.

Current printer carriage position measurement systems commonly employ codestrips having 150 graduations per inch, which can be satisfactorily resolved by this type of optical sensor. Thus, the distance between two rising edges in either the “A” or the “B” output signal corresponds to 1/150 inch. Thus, the distance between adjacent rising and falling edges in either of the “A” or the “B” output signals corresponds to 1/300 inch.

As is well appreciated in the art, increasing the resolution and accuracy with which the carriage position may be measured is desirable since it allows the dots making up an image to be more accurately located on the print media, thus making possible an improvement in the print quality of the output of the printer. Furthermore, where the optical sensor is used to measure marks printed on the print media for calibration purposes, increased resolution and positional accuracy of the carriage allows calibration routines to be performed to a greater accuracy.

Although the technology currently exists to enable the manufacture of codestrips with a significantly increased resolution, the size of the optical sensors used limits the resolution to which the carnage position may be measured. Different types of optical sensors with increased resolution, such as those used in specialist metrology applications, are available. However, the cost of such sensors is prohibitively high for use in a competitive, mass production market such as that of ink jet printers.

For some applications, the “A” and “B” signals of the standard optical sensors are XORed together. This effectively doubles the output resolution of the sensor to 600 dpi. However, problems exist wit this method of increasing position resolution. Firstly, each of the “A” and “B” signals of this type of sensor is generally not symmetrical. That is to say that the division between logical high and logical low outputs is generally not equal in a complete phase cycle, due to intrinsic characteristics of the sensor. Secondly, the phase difference between the “A” and “B” signals of this type of sensor is generally not precisely 90 degrees. Both of these factors thus introduce inaccuracies into the measured position of the carriage using this approach to increasing the sensor resolution. Clearly, for many applications, this is undesirable.

There is also a need for a position measurement system that is able to provide position information with a higher resolution than is currently available with such technology.

It would therefore be desirable to provide an improved position measurement system and method, which addresses the problems of the prior art.

### SUMMARY OF THE INVENTION

According to a first aspect of the present invention there is provided a sensor system for determining a position relative to a codestrip comprising a plurality of graduations spaced apart in a first direction, said system comprising first and second sensors arranged to move substantially in said first direction relative to said graduations and to output signals corresponding to the detection of said graduations, said system further comprising a differential screw adapted to adjust the spacing between said first and second sensors substantially in said first direction such that the outputs of said first and second sensors may be brought into a selected phase relationship.

By using two sensors that may be spaced apart in an accurate manner, several advantages may be realised. Firstly, by accurately adjusting the spacing between the sensors such that their respective outputs are 90 degrees out of phase and monitoring the changes in digital high and low of both sensor outputs, a measurement system of equal resolution but increased accuracy relative to the prior art may be realised. However, the present invention also offers the possibility of further increasing the measurement resolution. If using the above described sensor type, this may be done by XORing the two outputs of each sensor as described above. Alternatively, a third, or further sensor, accurately spaced relative the first or second sensor may be used to give increased measurement resolution.

By adjusting the distance between the first and second sensors using a differential screw a very fine adjustment in the sensor spacing may be achieved in a permanent or semi-permanent manner. A further advantage of using a differential screw is that the differential in pitch between the two screw threads may be selected to give the required degree of precision for the application.

A further advantage of the present invention is that it allows position information to be derived from non-continuous references, such as two separate codestrips. By using two sensors, spaced apart such that the output of one, when reading a first reference is in phase with the output of the other, when reading a second reference, a discontinuity between the references may be overcome without compromising positional accuracy.

A further advantage of the present invention is that the above described advantages may be obtained whilst using inexpensive sensors.

The present invention also provides excellent backward compatibility, providing a simple an inexpensive method of increasing the measurement resolution and accuracy of existing systems. In the case of printers, for example, systems according to the present embodiment may be adapted to work with existing printer carriages and chassis mountings.

The above described advantages lead to further advantages in the realms of printers and the like. Generally, printer carriage that reciprocate along a scan axis over the print zone suffer from a phenomenon, known as “jitter”, which is a high frequency variation in speed. This means that it is difficult to measure the position of the printer carriage accurately. Therefore, in order to ensure a high print quality output, the printing process is generally limited to periods when the print carriage is moving at a substantially fixed velocity. Thus, the printer may not print during the acceleration and deceleration phase that occur respectively before and after each pass of the printer carriage over the print zone. However, using the system of the present invention, it is possible to measure the position of the print carriage sufficiently accurately in order to be able to print whilst the printer carriage is accelerating and decelerating, without significantly affecting the print quality output. Thus, the speed of printing, and so, throughput may be increased.

The present invention also extends to the method corresponding to the apparatus and a jig arranged to support the sensor arrangement. Furthermore, the present invention also extends to a computer program, arranged to implement the method of the present invention,

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 shows a perspective view of a large format inkjet printer incorporating the features of the present invention;

FIG. 2 shows a schematic perspective view of the carriage portion of the printer of FIG. 1, illustrating part of the carriage position sensing system of an embodiment of the present invention;

FIG. 3 shows a perspective view of the position sensing system of FIG. 2 with the detail of the carriage removed;

FIG. 4 shows an elevation of the apparatus shown in FIG. 3;

FIG. 5 illustrates a partial plan view of the carriage assembly and carriage position sensing system shown in FIG. 2;

FIGS. 6a and 6b schematically illustrate the series of graduations in a codestrip;

FIG. 7 is a block diagram illustrating the apparatus used to calibrate the carriage position sensing system of an embodiment of the present invention;

FIG. 8a, 8b and FIGS. 9a-c schematically illustrate position measurement signals output by the position sensing system of the first embodiment of the present invention;

FIGS. 10a and 10b schematically illustrate position measurement signals output by the position sensing system of the second embodiment of the present invention;

FIG. 11 illustrates the arrangement of the position sensing system and the codestrips in the third embodiment of the present invention;

FIG. 12 schematically illustrates position measurement signals output by the position sensing system of the third embodiment of the present invention.

### DETAILED DESCRIPTION OF THE INVENTION

There will now be described by way of example only the best mode contemplated by the inventors for carrying out the invention.

System of the First Embodiment

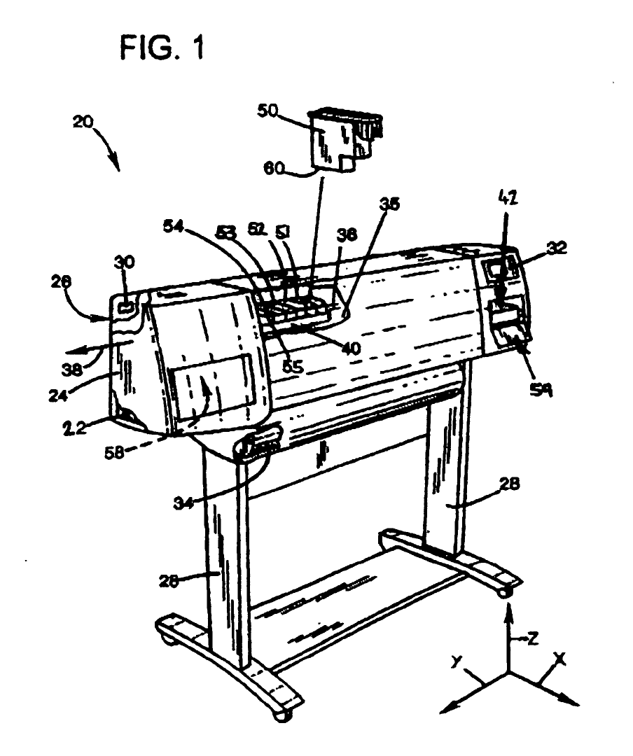

FIG. 1 illustrates an embodiment of an inkjet printing mechanism, here shown as a large format inkjet printer 20, which is suitable for use with the present invention and which may be used for printing conventional engineering and architectural drawings, as well as high quality poster-sized images. Commonly assigned U.S. Pat. No. 5,835,108, entitled “Calibration technique for misdirected inkjet printhead nozzles”, describes an exemplary system which can employ aspects of this invention and the entire contents of which are incorporated herein by reference.

While it is apparent that the printer components may vary from model to model, the typical inkjet printer 20 includes a chassis 22 surrounded by a housing or casing enclosure 24, typically of a plastic material, together forming a print assembly portion 26 of the printer 20. Although the print assembly portion 26 may be supported by a desk or tabletop, it is preferred to support the print assembly portion 26 with a pair of leg assemblies 28.

The printer 20 also has a printer controller, illustrated schematically as a microprocessor 30 that receives instructions from a host device, which is typically a computer, such as a personal computer or a computer aided drafting (CAD) computer system (not shown). The printer controller 30 may also operate in response to user inputs provided through a key-pad and status display portion 32, located on the exterior of the casing 24.

A carriage guide rod 36 is mounted to the chassis 22 to define a scanning axis 38, with the guide rod 36 slideably supporting an inkjet carriage 40 for travel back and forth, reciprocally, across the print zone 35.

In the print zone 35, the media sheet receives ink from an inset cartridge, such as a black ink cartridge 50, an enlarged view of which is shown in FIG. 1, and five monochrome colour ink cartridges 51 to 55. Each of the cartridges, often called “pens” by those in the art, is mounted on the inkjet carriage 40. The cartridges 51 to 55 are each arranged to print one of the following colour inks: cyan; magenta; yellow; light cyan; and, light magenta. In the present embodiment, each of the pens 50 to 55 contains dye-based ink although pigment based ink could alternatively be used.

The illustrated pens 51 to 55 each have a printhead (of which only printhead 60 of the pen 50 is illustrated in the figure), which selectively ejects ink to form an image on a sheet of media 34, in this embodiment held in the form of a roll, in the print zone 35. Each printhead has an orifice plate with a plurality of nozzles formed therethrough in a manner well known to those skilled in the art. In the present embodiment, the printheads are thermal inkjet printheads, although other types of printheads may be used, such as piezoelectric printheads.

Periodically, servicing routines as are known in the art may be carried out on the pens in the servicing region 42 of the printer, which is accessible to the user through door 59.

The illustrated printer 20 uses an “off-axis” ink delivery system, having main stationary reservoirs (not shown) for each ink colour located in an ink supply region 58. In this off-axis system, the pens 50 may be replenished by ink conveyed through a conventional flexible tubing system (not shown) from the stationary main reservoirs. In this manner, only a small ink supply is propelled by carriage 40 across the print zone 35, which is located “off-axis” from the path of printhead travel.

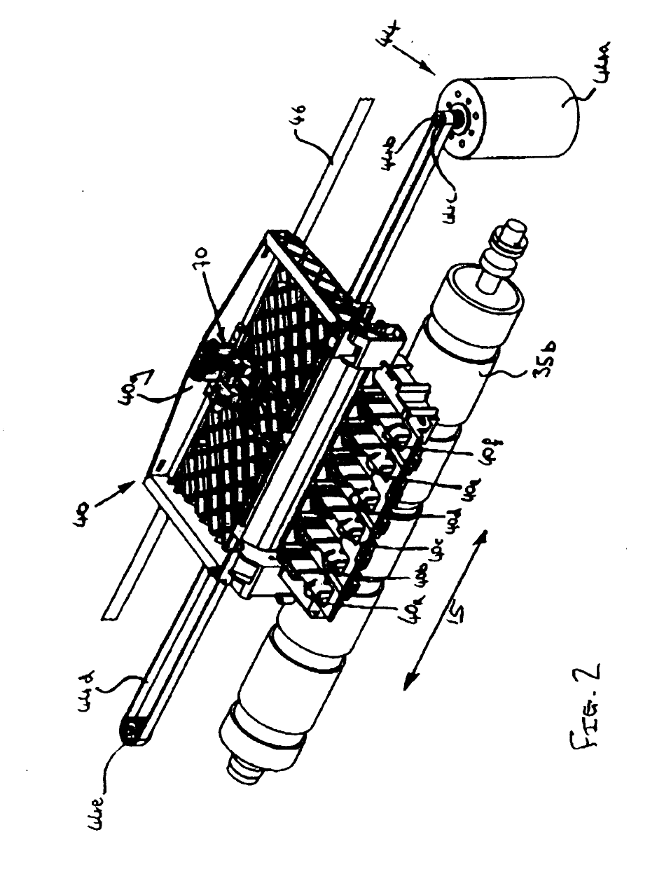

The printer 20 also includes a carriage positioning mechanism 44, shown in FIG. 2, that determines the position of the carriage assembly 40 along the scan axis 38 with respect to a codestrip 46. FIG. 2 shown a perspective view of the carriage positioning mechanism 44 and the codestrip 46 together with the carriage assembly 40, which has six slots 40a-40f arranged to support the six print cartridges 51 to 55. The carriage assembly 40 is positioned above a media roller 35b, which is arranged to feed the print media in the X-axis direction along the media feed path.

The carriage positioning mechanism 44 includes a conventional carriage drive motor 44a that may be used to propel the carriage 40 in response to a control signal received from the controller 30. The carriage drive motor 44a drives a belt 44d via a drive shaft 44b and a drive pulley 44c. The belt 44d, which is entrained about an idler pulley 44e, is connected to the carriage assembly 40 at a connection point (not shown). In this manner, the carriage assembly 40 may be moved in a positive or a negative direction along the guide rod 36 (shown in FIG. 1), as is indicated by the arrow 15 in FIG. 2, in dependence upon the direction of rotation of the motor 44a.

The position of the carriage assembly 40 along the scan axis 15 is determined precisely using a codestrip 46, together with an optical sensor system 70, as is described in more detail below. The codestrip 46 is secured between first and second stanchions (not shown), such that it is parallel to the scan direction of the carriage assembly 40 and extends across the width of the print zone 35 and over the servicing region 42.

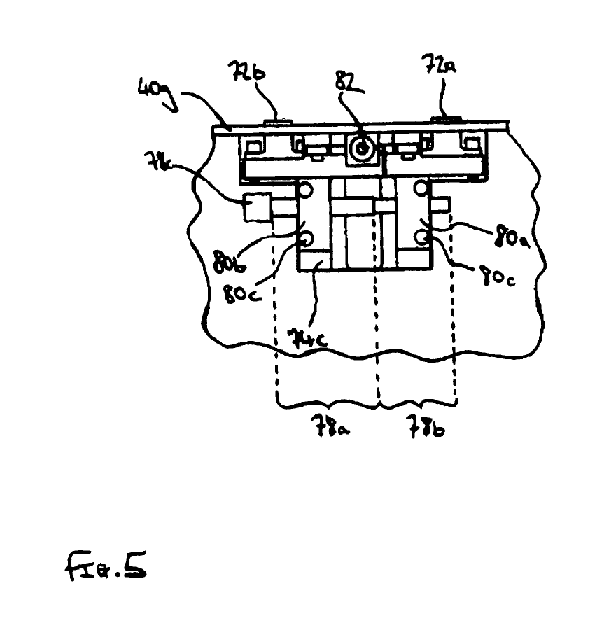

Any suitable commercially available codestrip may be used in the present embodiment. Such codestrips are available from PWB-Ruhlatec, Industrial Products Gmbh, Siegburger Str. 39c, D-53757 St. Augustin, Germany. In the present embodiment, the codestrip 46 has a series of graduations 46a formed on it, arranged perpendicular to the length of the codestrip 46 as are schematically illustrated in FIG. 6a. As can be seen from FIG. 6b, which schematically illustrates an enlarged partial view of the code strip of FIG. 6a, the graduations are equi-spaced at a pitch of 0.1693 mm; i.e. the distance between corresponding points (e.g. the left hand edges) in adjacent graduations 46a is 0.1693 mm (1/150 inches) and the width of each graduation 46a and spacing between adjacent graduations is 0.0847 mm (1/300 inches). Typically, the codestrip 46 is manufactured from a plastics material such as Mylar™ and is formed using a laser plotter by writing to the film in a longitudinally progressive manner along the length of the codestrip 46.

The optical sensor system 70 is disposed on the carriage assembly 40 and is arranged read the codestrip 46 and to output carriage position signals that are utilised by the controller to determine the position of the carriage assembly 40 in the scan axis 15, as the carriage moves relative to codestrip 46.

The printer 20 also includes a conventional print media handling system (not shown) to advance a sheet of print media 34 through the printzone 35. The print media 34 may be any type of suitable sheet material, such as paper, poster board, fabric, transparencies, Mylar™ and the like.

The carriage position in the Y-axis and the position of the print media in the X-axis is output to the print controller 30. In this manner, the print controller 30 may generate control signals causing the carriage assembly 40 to be moved in the Y-axis and the print media to be moved in the X-axis, such that the pens may print ink at any desired location on the printing area of the print medium.

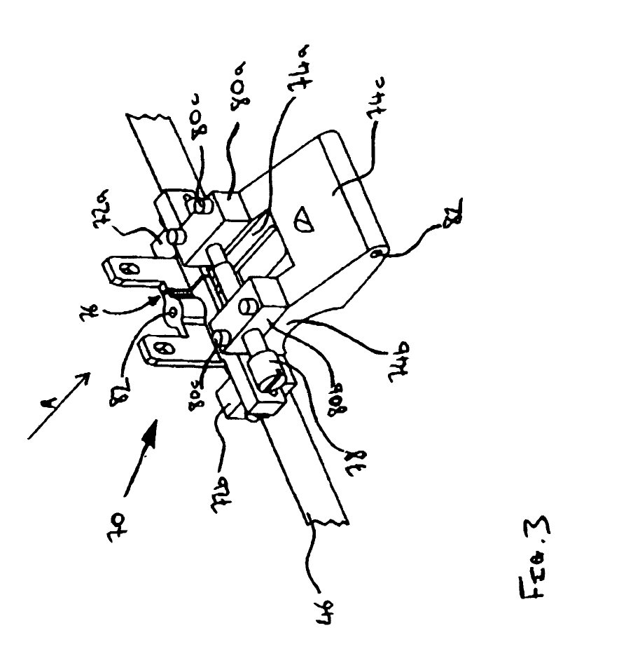

Referring now to FIGS. 3, 4 and 5, the optical sensor system 70 of the present embodiment will now be described. In the present embodiment, the optical sensor system comprises two optical sensors 72a and 72b, of the type discussed with reference to the prior art above. They are arranged to read the codestrip 46, and mounted on a supporting jig assembly 74 that is in turn mounted on the carriage assembly 40.

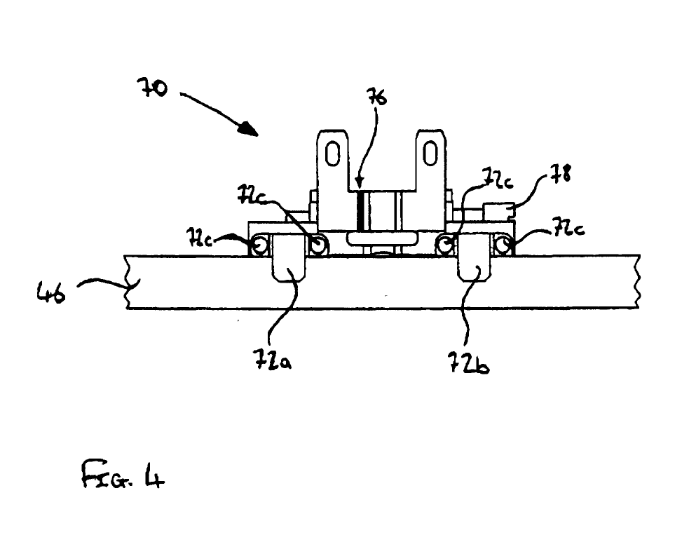

FIG. 3 shows a perspective view of the jig assembly 74 and the codestrip 46, with the detail of the carriage assembly 40 removed. FIG. 4 shows an elevation in the direction of arrow “A” of the apparatus shown in FIG. 3. FIG. 5 illustrates a partial plan view of the carriage assembly 40 shown in FIG. 2, in which the optical sensor system of the present embodiment has been installed.

As is shown in FIG. 3, the jig 74, is broadly speaking “C” shaped, having two arm portions 74a and 74b interconnected by a body portion 74c. In the present embodiment, the jig 74 is manufactured from an aluminium alloy using a die casting process. As can be seen from each of FIGS. 3 to 5, a gap 76 exists between the two arm portions 74a and 74b; i.e. the arm portions 74a and 74b are connected together only by the body portion 74c of the jig. Thus, due to the natural resilience of the material from which the jig 74 is formed, each arm portion 74a and 74b is able to flex independently of the other relative to the body portion 74c of the jig.

As can be seen most clearly in FIG. 4, the two low cost optical sensors 72a and 72b are rigidly mounted upon the arm portions 74a and 74b respectively of the jig 74, using screws 72c. In the present embodiment, the sensors used are sensor model HEDS9200, available from Hewlett Packard Company. However, any other suitable sensors may instead be used. This type of sensor is provided with a slot through which the codestrip 46 may pass as it is read by the sensors as they move relative to the codestrip 46.

A light source (not shown), typically an LED, is associated with each sensor 72a and 72b and is arranged to project a light beam through the codestrip 46 and towards the respective sensor. In use, the graduations of the codestrip 46 cause light directed towards each sensor to be alternately obstructed and transmitted, as the carriage and its light beam pass along the stationary codestrip 46. The sensor responds to the resulting variations in received light with a correspondingly varying electrical signals. The signals are output to the controller 30. The controller 30 interprets the signals, counting them and developing from them information not only about position but also about velocity of the carriage along the scan axis. The processor 30 is then able to output signals to the motor 40a to stabilize and maintain the velocity the carriage as it traverses the image areas of the sheet.

As can be seen from FIGS. 3 to 5, a differential screw 78 is supported between the arms 74a and 74b of the jig 74. The differential screw 78 is a rod or bolt upon which two or more threaded portions of different pitches have been machined. In the case of the present embodiment, as is most clearly shown in FIG. 5, the differential screw 78 comprises three portions: a head portion 78c with which the screw may be turned; and, two threaded portions 78a and 78b of different diameter. As will be apparent from the following description, it is not necessary for the differential screw 78 to have threaded portions 78a and 78b of different diameters. However, in this embodiment, it facilitates the assembly of the completed jig assembly. Both of the portions 78a and 78b are threaded along the entirety of their length (although the threading is not illustrated in the Figures). The difference in pitch between the threaded portions 78a and 78b is 0.05 mm.

In order that the differential screw 78 may be assembled with the jig 74, it is first assembled with two attachment portions 80a and 80b that are drilled and tapped to accept the threaded portion 78a and 78b, respectively, of the differential screw 78. The two attachment portions 80a and 80b are then rigidly mounted on the arms 74a and 74b, respectively, of the jig 74, to form the completed jig assembly. In the present embodiment the attachment portions are each mounted on the arms using two screws 80c. However, any other suitable attachment method may instead be used.

The completed jig assembly is assembled with the carriage assembly 40, as is shown in FIGS. 2 and 5, such that the optical sensors 72a and 72b are mounted so as to protrude through apertures (not shown) in the wall 40g of the carriage assembly 40. Thus, the sensors 72a and 72b have an unobstructed access to the codestrip 46. The sensors 72a and 72b and the codestrip 46 are positioned and orientated relative to each other in a conventional manner known in the art, such that the sensors 72a and 72b can effectively detect graduations of the codestrip 46 as the carriage moves along the scan axis.

The arm portion 74b and the body portion 74c of the jig 74 are fixed rigidly to carriage assembly 40 using screws at screw locations 82 in the jig structure. However the arm portion 74a of the jig is not rigidly fixed to the carriage assembly 40. In this manner, the arm portion 74a remains able to flex relative to the arm portion 74b and the body portion 74c of the jig, against the natural resilience of the material from which the jig 74 is formed. Thus, by flexing the arm portion 74b, the spacing between the sensors 72a and 72b may be increased or decreased.

The spacing between the sensors 72a and 72b may be adjusted by rotating the differential screw 78. Since the threaded length of each of the threaded portions 78a and 78b extends significantly to either side of the respective attachment portions 80a and 80b, the differential screw 78 may be screwed into or out of the attachment portions 80a and 80b. When the differential screw 78 is screwed into or out of the completed jig assembly (i.e. rotated in either rotational sense whilst located in the completed jig assembly), the differential screw 78 travels a different distance along its longitudinal axis relative to each of the attachment portions 80a and 80b. This is due to the difference in pitch of the threads in the threaded portions 78a and 78b.

Therefore, by turning the differential screw in one direction, the arm 74a is forced closer to arm 74b, by virtue of the fact that the arms 74a and 74b are rigidly connected to the attachment portions 80a and 80b respectively; thereby decreasing the separation between the optical sensors 72a and 72b. Conversely, by turning the differential screw in the opposite direction, the arm 74a is forced further from arm 74b; thereby increasing the separation between the optical sensors 72a and 72b.

The skilled reader will appreciate that the difference in the pitch between the threaded portions 78a and 78b of the differential screw determines the precision with which the distance between the sensors may be adjusted. Thus by ensuring that the difference in pitch is small, the extent to which the differential screw 78 must be turned in order to significantly change the separation between the two sensors 72a and 72b is large. Conversely, very small changes in the separation of the sensors 72a and 72b may be very accurately achieved using relatively large rotations of the differential screw 78. In the case of the present embodiment where the difference between the pitch of the threaded portions 78a and 78b is 0.05 mm, each complete turn of the differential screw 78 will change the distance between the sensors 72a and 72b by 0.05 mm. The skilled reader will of course appreciate that the distance between the sensors 72a and 72b may be adjusted more precisely by turning the differential screw a fraction of a turn.

Method of Operation of the First Embodiment

In the present embodiment, both the “A” and the “B” signals from both of the sensors 72a and 72b are used in order to increase the resolution with which the position of the carriage assembly may be measured.

Prior to first using the optical sensor system of the present embodiment, a calibration procedure is implemented to precisely adjust the spacing between the sensors 72a and 72b. In this manner, the phase relationship between the outputs of sensors 72a and 72b is adjusted using the differential screw 78 such that the phase of the output of one of the sensors leads the phase of the output of the other sensor by 45 degrees. The skilled reader will appreciate that in order to achieve this, it is not important which sensor output leads and which follows, as long as the desired phase separation is achieved. Furthermore, the exact number of the codestrip graduations separating the two sensors may vary, as long as the desired phase separation is achieved.

Thus, when using a codestrip having a resolution of 150 graduations per inch (corresponding to a graduation pitch of 0.169 mm), the spacing between the sensors is adjusted to be an integer multiple of 0.0423 mm or 1/600 inches (corresponding to an integer multiple of 90 degrees of phase difference of the output signal of a sensor) plus or minus 0.0212 mm or 1/200 inches (corresponding to 45 degrees of phase difference of the output signal of a sensor).

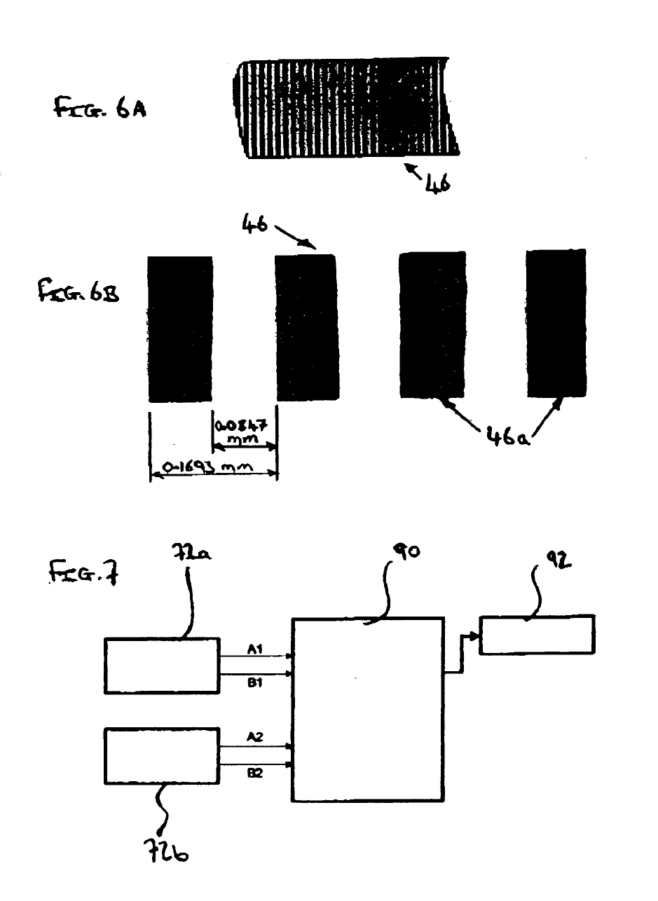

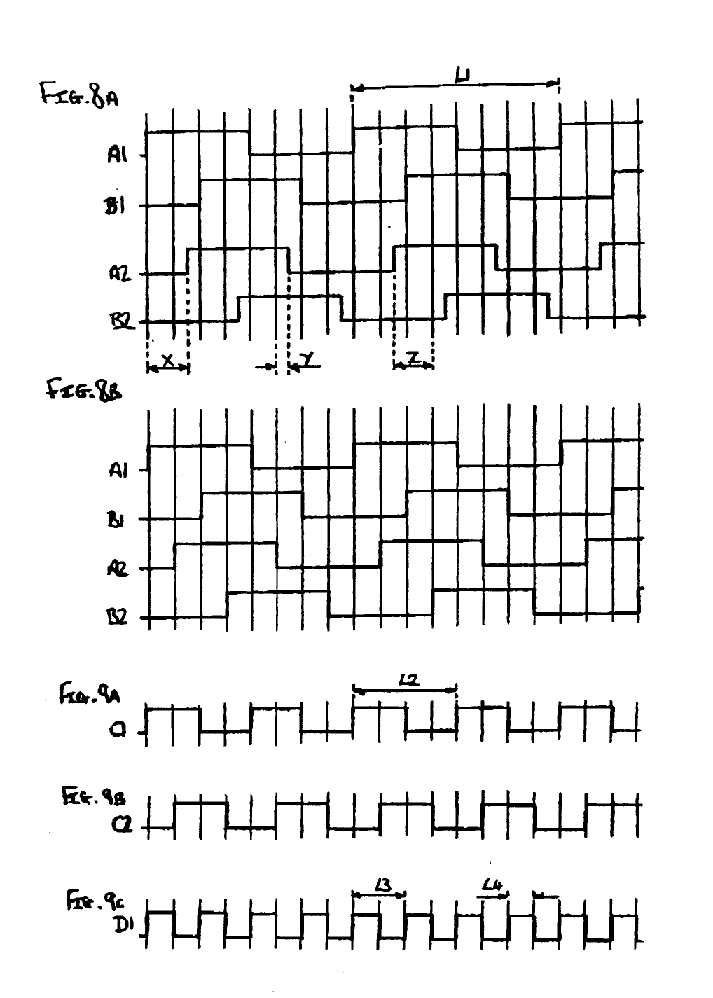

This procedure will now be described with reference to FIGS. 7 and 8. Turning now to FIG. 7, a schematic diagram representing the calibration apparatus is illustrated.

As can be seen in the figure, the “A” and “B” outputs of both of the sensors 72a and 72b are connected to a counter and processing module 90, using any suitable electrical connection. The counter and processing module 90 is in turn connected to a display device 92. In the present embodiment, the counter and processing module 90 together with the display device 92 is a standard personal computer (PC) and video display unit. The PC runs a suitable operating system, such as Windows 2000™ and is programmed with suitable commercially available signal analysis software.

The display device 92 is arranged to display the signals received from the sensors 72a and 72b and information generated by the counter and processing module 90 that an operator may use to carry out the calibration procedure. Although in the present embodiment a PC is used, the skilled reader will appreciate that in other embodiments, a purpose designed processing device and a screen such as a LCD display could be used in its place.

The carriage assembly 40 is then moved relative to the codestrip 46. This may be under the control of the carriage drive motor 44a and printer controller 30 or manually. The graduations in the codestrip 46 cause the light emitted from each light source to be alternately obstructed from, and rived by the associated sensor as the carriage assembly 40 passes along the stationary codestrip 46. The sensors 72a and 72b respond to the resulting variations in received light by generating correspondingly varying “A” and “B” output signals. Hereafter the “A” and “B” signals output by sensor 72a are respectively referenced A1 and B1, and the “A” and “B” signals output by sensor 72b are respectively referenced A2 and B2.

The counter and processing module 90 measures the pulse widths and the relative phases of the received signals A1, B1, A2 and B2. Preferably, a large number of measurements are taken from which average values are calculated. For example, the carriage assembly 40 could be moved the entire way across the scan axis 38 during this measurement step. Thus, the measured pulse width for the signals output by each sensor 72a and 72b and the measured phase difference between the sensors 72a and 72b would be an average generated from substantially all of the graduations along the length of the codestrip 46. In this manner, any localised measurement errors, due for example to variability in the codestrip 46, will be minimised.

Referring to FIG. 8a, exemplary output traces are schematically shown, illustrating the pulse widths and the relative phases of received signals A1, B1, A2 and B2. As is shown in the figure, the distance “L1” between two consecutive rising edges in each of the signals A1, B1, A2 and B2 corresponds to the distance between corresponding points (e.g. the left hand edges) in adjacent graduations 46a of the codestrip. i.e. 0.1693 mm (1/150 inches). Thus, the distance between adjacent rising and falling edges in either of the “A” or the “B” output signals corresponds to 0.0847 mm (1/300 inch).

As can be seen from the figure, within the tolerances of the sensors 72a and 72b, the A signal (A1; A2) of each sensor is 90 degrees out of phase with the B signal (B1; B2) of that sensor. However, at this stage the phase relationship between the outputs of the two sensors is arbitrarily arranged. In this example, as can be seen from the figure, the signals output by sensor 72a (A1 and B1) each lead the corresponding signal output by sensor 72b (A2 and B2, respectively) by a phase difference of between 45 and 90 degrees. The exact phase difference, indicated on the figure as “X”, is measured and stored by the counter and processing module 90.

As has been explained above, in the present embodiment it is required that the phase difference between the two sensors should be 45 degrees. As the skilled reader will appreciate, in order to increase the output resolution of the sensor system it is not important whether the output of one sensor leads or lags the output of the other, merely that the phase difference between the two sensors should be 45 degrees. Thus, the calibration process may advance or delay the output of either sensor in order to achieve this aim. In this example, the output of sensor 72b (including outputs A2 and B2) may be advanced (i.e. shifted to the left in the figure) relative to the outputs A1 and B1 of sensor 72a by the phase advance represented by distance “Y”. Alternatively, the output of sensor 72b (including outputs A2 and B2) may be delayed (i.e. shifted to the right in the figure) relative to the outputs A1 and B1 of sensor 72a by the phase advance represented by phase shift “Z”.

The counter and processing module 90 then calculates an adjustment in the phase difference of the two sensors 72a and 72b, corresponding to a phase change represented by “Y” or “Z” in the figure, required to make the phase difference between the two sensors equal 45 degrees. From the required adjustment in the phase difference of the two sensors 72a and 72b, the counter and processing module 90 calculates the required increase or decrease in the physical separation of the two sensors 72a and 72b in order to bring this about. From this linear distance, the required rotational direction and angular distance that the differential screw 78 must be turned in order to bring about the required change in phase is calculated.

The counter and processing module 90 then displays this information on the display 92 in order that an operator may adjust the spacing between the two sensors 72a and 72b as required. This information may be displayed in a variety of ways, including user intuitive graphics, for example. However, irrespective of the form of the output display, the operator should be able to identify at least an approximate angle by which the differential screw 78 should be turned in a given direction in order that the distance between the two sensors converges on a distance giving the required phase relationship between their outputs.

Once the operator has adjusted the distance between the sensors 72a and 72b, the phase difference between the outputs of the sensors 72a and 72b may be verified by repeating the calibration process. The calibration process may thus be repeated until the phase difference between the sensor outputs is achieved to the required accuracy. The desired phase relationship between the outputs of sensor 72a and 72b is shown in FIG. 8b. As can be seen from the figure, output signals A1, B1, A2 and B2 change state (been logical high and logical low) in the repeating order of: A1, A2, B1, B2. The phase difference between consecutive changes in state is 45 degrees. Thus, in a given output cycle of any one of the sensor outputs, corresponding to “L1”, eight equi-spaced changes in state will be detected. Thus, the distribution of the changes in state may be described as phase equi-spaced.

Once the calibration process is completed, the sensors 72a and 72b are disconnected from the counter and processing module.

In the preferred embodiment. the differential screw 78 is treated with an adhesive that is activated by the act of turning of the differential screw 78 in the attachment portions 80a and 80b. Thus, shortly after the calibration procedure is completed, the adhesive dries permanently securing the differential screw 78 in the correct position relative to the two attachment portions 80a and 80b. In this manner, the required phase difference between the two sensors is preserved. Any suitable adhesive may be used for this purpose, for example Patch-Lock™.

Referring now to FIG. 9, the method by which the position of the carriage assembly is detected by the sensor system of the present embodiment will now be described.

As the carriage assembly 40 traverses the scan axis 38 during normal operation, the outputs from the two sensors 72a and 72b are output to the controller 30. The controller 30 implements a logical XOR function on the signals A1 and B1, giving rise to a signal C1, shown in FIG. 9a. The controller 30 also implements a logical XOR function on the signals A2 and B2, giving rise to a signal C2, shown in FIG. 9b. The signals C1 and C2 represent carriage position signals with double the resolution of signals A1, B1, A2, and B2, since the period “L2” of the signals C1 and C2 is half that of A1, B1, A2, or B2. Thus, the period “L2” corresponds to a distance of 0.0847 mm (1/300 inches).

The controller 30 then implements a further logical XOR function on the signals C1 and C2, giving rise to a further signal D1, shown in FIG. 9c. The signal D1 represent carriage position signals with four times the resolution of signals A1, B1, A2, and B2, since the period “L3” of the signals D1 is ¼ that of A1, B1, A2, or B2. Thus, the period “L3” corresponds 0.0423 mm (1/600 inches). Thus, using the position measurement method of the present embodiment, it is possible to determine the position of the carriage 40 to within a distance of 0.0212 mm (1/1200 inches) along the codestrip 46; i.e. the distance “L4” between a consecutive pair of rising and falling edges of the signal D1.

The skilled reader will appreciate that in the present embodiment, it is possible to arrange the spacing between the sensors correctly whilst monitoring only a single output from each sensor, since the phase relationship between the two outputs of each sensor is known. However, by monitoring both signals of each sensor, it is possible to thoroughly test the operation of each output of both sensors.

The skilled reader will also appreciate that it is not necessary to use a PC with signal analysis software in the present embodiment in order to correctly arrange the relative phases of the sensor outputs. In practice, this may instead be carried out using a standard oscilloscope and manual measurement and adjustment of the signals.

Second Embodiment

The second embodiment fulfils substantially the same function as described with reference to the first embodiment and employs substantially the same apparatus and procedures. Therefore, like functions, structures and procedures will not be described further in detail.

The skilled reader will of course appreciate that in some applications, the inaccuracies introduced into the measured position of the carriage assembly 40 by using both the “A” and “B” signals of the two sensors 72a and 72b are unacceptable. Therefore, in the present embodiment, only one output signal is used from each of the sensors 72a and 72b. In this manner, the positional inaccuracies caused by using the “A7” and “B” signals from the same sensor which are not precisely separated by 90 degrees may be avoided. However, the resolution with which the position of the carriage assembly 40 may be measured in the present embodiment is reduced with respect to that of the first embodiment.

Therefore, in the present embodiment, either signal “A1” or “B1” may be selected from the first sensor 72a and either of signal “A2” or “B2” may be selected for from the second sensor 72b for use in measuring the position of the carriage 40.

In the present embodiment, the separation of the two sensors 72a and 72b is adjusted using a calibration procedure that is substantially the same as that described above with respect to the first embodiment, therefore, it will not be described again in detail. Since only one output is to be used from each sensor to determine the position of the carriage assembly 40 in this embodiment, the separation of the two sensors 72a and 72b is adjusted to ensure that the output signal of the sensor 72a leads or lags the output signal of the sensor 72b by 90 degrees. In this manner, the distribution of the changes in state in the output signals are again phase equi-spaced.

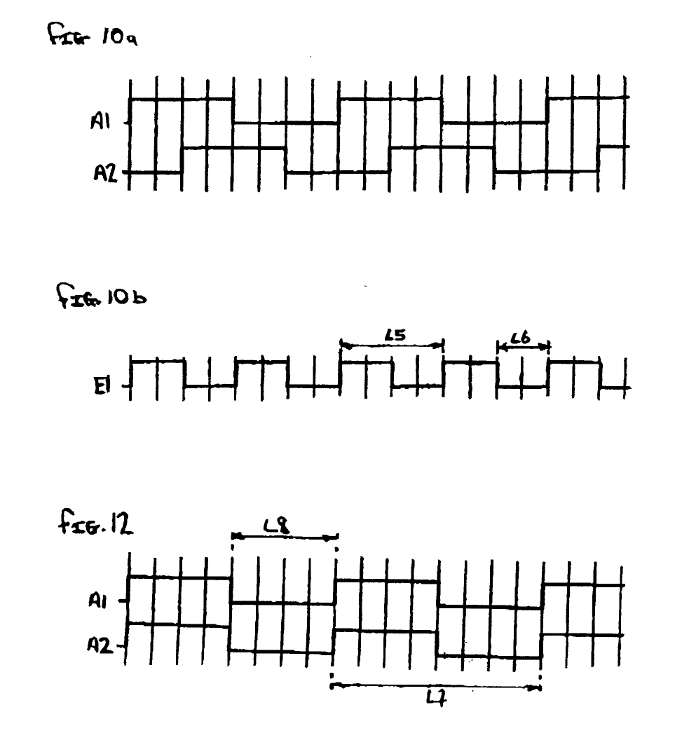

In the present example signals “A1” and “A2”, from sensors 72a and 72b respectively, are selected for use in measuring the position of the carriage 40. In the same manner as has been described with respect to the first embodiment, their physical spacing is adjusted to give the required phase difference between the signals “A1” and “A2”. As has been described above, in this embodiment, the spacing is 90 degrees. The phase adjusted signals are illustrated in FIG. 10a.

In operation, as the carriage assembly 40 traverses the scan axis 38, the outputs signals “A1” and “A2” are output to the controller 30. As has been described with respect to the first embodiment, the controller 30 implements a logical XOR function on the signals A1 and A2, giving rise to the signal E1, shown in FIG. 10b. The signal E1 represents a carriage position signal giving double the resolution of signals A1 or A2, since the period “L5” of the signal E1 is half of that of the period, L1, of signals A1 and A2. Thus, the period “L5” corresponds 0.0847 mm (1/300 inches). Thus, using the position measurement method of the present embodiment, it is possible to determine the position of the carriage 40 to within a distance of 0.0423 mm (1/600 inches) along the codestrip 46, without incurring the inaccuracies of the prior art method; i.e. the distance “L6” between a consecutive pair of rising and falling edges of the signal E1.

Third Embodiment

The third embodiment employs substantially the same apparatus and procedures as described with reference to the first and second embodiments. Therefore, like structures and functions will not be described further in detail. However, whereas the aim of the first and second embodiments was to increase the resolution and or accuracy with which the position of the carriage assembly may be measured, the aim in the third embodiment is primarily to increase the length of codestrip that can be may be used, especially in regard to printers and scanners and the like having scan axes of increased width.

The length of codestrips is currently limited by the high cost of the machinery to required to make manufacture them. However, as demand requires printers with increasingly wide scan axes, longer codestrips are required. Due to the high resolution of the graduations recorded on a codestrip, it is not generally practicable to join two codestrips end-to-end to increase their usable length, without causing substantial positioning errors in the region of the join. This is because it is generally not practicable to ensure that the last graduation of one codestrip is separated from the first graduation of the next codestrip by the correct distance. This distance, if too great, may cause a gross positioning error in the region of a gap between the two codestrips, where no graduations are present. Furthermore, whether the distance is too great or too small, the signals generated by a sensor reading one codestrip may be phase shifted relative to the signals generated when reading the next codestrip. Of course, both of these factors will cause carriage position measurement errors.

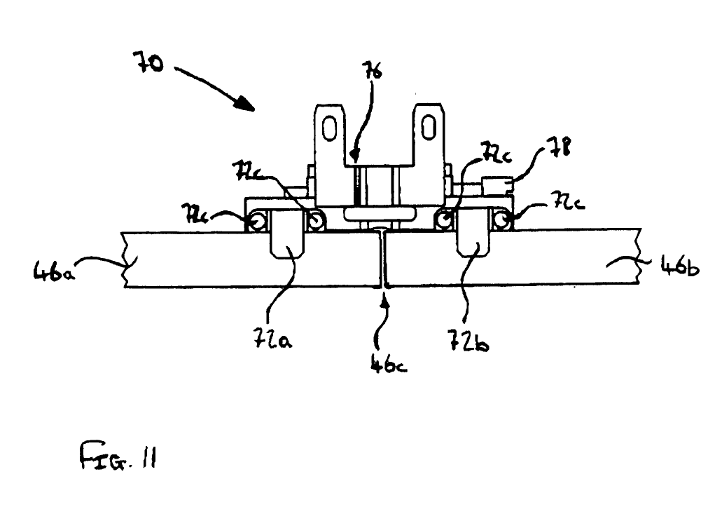

The present embodiment will now be described with reference to FIGS. 11 and 12.

FIG. 11 shows an elevation of the jig 74 and sensors 72a and 72b, as shown in FIG. 4, with respect to the first embodiment. The carriage assembly 40, jig 74 and arrangement of the sensors in the present embodiment are identical to the equivalent structures in the first and second embodiments and function in the same manner. Therefore, they share the same reference numerals as used in the first embodiment and they will not be described further.

As can be seen from the FIG. 11, however, two codestrips 46a and 46b are positioned in an end-to-end manner, parallel to the direction of motion of the carriage assembly 40 in place of the single codestrip 46 used in the first embodiment. As can be seen from the figure, a small gap 46c is present between the abutting ends of the two codestrips 46a and 46b. Since each codestrip 46a and 46b may be equally long as the codestrip 46 used in the first embodiment, the overall length of the scan axis 38 in the present embodiment may be up to approximately twice the length of that in the first embodiment.

In the present embodiment, the two codestrip 46a and 46b are suspended from suspensions points (not shown), positioned along their lengths, instead of being secured at either end by stanchions, as was described above with reference to the first embodiment. In this manner, a neat transition between the two codestrips 46a and 46b may be obtained. This technique of codestrip mounting is described in European Patent Application Number 1 029 696A1, in the name of Hewlett Packard Company, which is hereby incorporated by reference in its entirety.

In the present embodiment, each sensor 72a and 72b is arranged to read the position of the carriage assembly 40 from a different one of the two codestrips 46a and 46b. In this example, the sensor 72a is arranged to read the position of the carriage assembly 40 from the codestrip 46a and the sensor 72b is arranged to read the position of the carriage assembly 40 from the codestrip 46b. Thus, as the carriage assembly moves along the scan axis 38 adjacent to the codestrip 46a, the carriage position information is derived from the sensor 72b in the normal way.

However, as the carriage moves from being adjacent to the codestrip 46a to being adjacent to the codestrip 46b, the carriage position information is then derived from the codestrip 46b by the sensor 72b only, also in the normal way.

However, in order to ensure that substantial positioning errors do not occur due to the join between the two codestrips 46a and 46b the separation of the two sensors 72a and 72b is adjusted using a calibration process that is substantially the same as that described with reference to the first embodiment. Again, in this calibration procedure, only one output signal is required from each of sensors 72a and 72b. In the present example signals “A1” and “A2”, of the sensors 72a and 72b respectively, are used.

The carriage assembly 40 is positioned such that the two sensors 72a and 72b are located on either side of the gap 46c between the two codestrips 46a and 46b. The carriage assembly 40 is then moved in one direction along the scan axis such that neither of the sensors 72a and 72b cross the gap 46c between the two codestrips 46a and 46b. Thus, the sensor 72a outputs position signals measured from codestrip 46a and the sensor 72b outputs position signals measured from codestrip 46b. Again, the carriage assembly 40 may be moved either under the control of the carriage drive motor 44a and printer controller 30 or manually.

The counter and processing module 90 then measures the relative phases of the received signals A1 and A2 during this movement of the carriage assembly 40.

In this embodiment, the counter and processing module 90 then calculates the required adjustment in the relative phases of the two sensors 72a and 72b, to ensure that there is no phase difference between the signals “A1” and “A2”; i.e. that the signals “A1” and “A2” are in phase. The required increase or decrease in the physical separation of the two sensors 72a and 72b in order to bring this about is also calculated to be implemented by an operator in the manner previously described.

In this manner, the separation of the two sensors 72a and 72b is precisely adjusted such that the output of sensor 72a, whilst reading the graduations of codestrip 46a, is precisely in phase with the output of sensor 72b, whilst reading the graduations of codestrip 46b; as is illustrated in FIG. 12. Again, it will be appreciated that the size of the gap between the codestrips 46a and 46b may vary, provided that it is less than the spacing between the sensors 72a and 72b. Similarly, the exact number of codestrip graduations spanned by the two sensors may also vary, as long as the desired phase separation is achieved.

Therefore, in use, whilst both sensors 72a and 72b are located adjacent to codestrip 46a, the controller 30 derives carriage position information from the sensor 72a in the normal way. In this situation, the phase relationship between the two sensors 72a and 72b may be arbitrary. However, as the carriage assembly 40 moves from left to right as viewed in FIG. 11, and the sensor 72b crosses the gap 46b, the phase of the output of sensor 72b comes into phase with the output of sensor 72a. However, as the carriage assembly 40 continues to move in the same direction, and the sensor 72a crosses the gap 46b, the phase relationship between the two sensors 72a and 72b returns to being arbitrary. Once the sensor 72a reaches the end of the codestrip 46a, the controller 30 derives carriage position information from the sensor 72b in the normal way. When the carriage assembly 40 changes direction along the scan axis 38, the process is repeated in reverse.

The controller 30 is thus able to multiplex between the output signals of the two sensors 72a and 72b as the carriage assembly passes the join between the two codestrip 46b (i.e. when the phase of the outputs of sensors 72a and 72b are in phase) in order to ensure that no positional errors are caused by the join between the two codestrips 46a and 46b. The exact moment at which the controller 30 switches reliance between the output of one sensor and the output of the other is preferably selected at any point whilst the outputs of the sensors are in phase.

In the present embodiment, the period of output signals “A1” and “A2”, as indicated by “L7” corresponds to 0.1693 mm (1/150 inches). Thus, using the position measurement method of the present embodiment, it is possible to determine the position of the carriage 40 to within a distance of 0.0847 mm (1/300 inches); i.e. the distance “L8” between adjacent rising and falling edges in each of the signals A1, or A2, as is shown in the figure. However, it will be appreciated that in practice, the resolution with which the position of the carriage assembly 40 is measured may be doubled by carrying out a logical XOR function between the “A” and “B” signals output by each sensor 72a and 72b, as described above.

The skilled reader will appreciate that the present embodiment may also be used in order to test codestrips. By setting the phase separation of the output of two sensors to a known value at one point in the codestrip, it is possible to detect relative variations in the spacing of graduations in other portions of the codestrip. Such variations will be cause a change in the phase difference between the outputs of the sensors.

Further Embodiments

In the above description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

For example, the skilled reader will appreciate that although the above embodiments were described with reference to a wide format printer, it will be understood that the present invention may be applied to a wide range of devices where position information is derived from a codestrip. These may include desk-top printers, copiers, and facsimile machines and scanners to name but a few.

It will also be appreciated that the features of the third embodiment could be combined with those of the first or the second embodiments in order to increase the resolution with which position can be measured, when two or more codestrips are joined end to end. This may be achieved, for example, by using two optical sensor systems 70 according to the first or second embodiments (each with associated jig and differential screw) spaced apart from each other by a selected distance by a third differential screw according to the third embodiment.

The skilled reader will also appreciate that there are various ways in which the measurement resolution of a system according to the present invention may be increased. Firstly, a differential screw with a smaller differential (i.e. a smaller difference in the pitch of the two threaded portions) would allow finer adjustment. Secondly, optical sensor systems as described above could be used with codestrips of finer resolution, together with higher precision sensors. Additionally, the skilled reader will appreciate that the present invention could be applied to an optical sensor system using three or more optical sensors. In the case of a three optical sensor system, for example, a jig assembly would be used that allows the relative spacing between each of the three optical sensors to be precisely adjusted, through the use of two independently operable differential screws. By increasing the number of changes in state (between logical high and logical low) that can be measured for a given movement of the sensor system relative to a codestrip, the resolution and accuracy of the system may be increased.

Furthermore, although in the above described embodiments the relative phases of the output signals were adjusted in order to ensure that distribution of the changes in state were phase equi-spaced, the skilled reader will appreciate that in practice this need not be the case. By ensuring that distribution of the changes in state are phase equi-spaced, it is possible to measure positions along a scale in constant distance increments. However, provided that the phase relationships or differences between the various sensor signals are known, a measurement scale may be usefully be implemented where this is not the case. For example, three sensors could be used having phase separations in which the output of a first sensor leads that of a second sensor by 45 degrees and leads that of a third sensor by 90 degrees.

Additionally, although in the above described embodiments the sensors used were optical sensors, the skilled reader will appreciate that in practice other sensors such as magnetic sensors may instead be used.

Although in the above embodiments, the process of adjustment of the spacing between the optical sensors is made manually, the skilled reader will appreciate that it may instead be carries out automatically under the control of the counter and processing module.

What is claimed is:

1. A sensor system for determining a position relative to a codestrip comprising a plurality of graduations spaced apart in a first direction, said system comprising first and second sensors arranged to move substantially in said first direction relative to said graduations and to output signals corresponding to the detection of said graduations, said system further comprising a differential screw adapted to adjust the spacing between said first and second sensors substantially in said first direction such that the outputs of said first and second sensors may be brought into a selected phase relationship.

2. A system according to claim 1, wherein said output of the first sensor leads or lags said output of the second sensor by approximately 90, or 60, or 45 degrees.

3. A system according to claim 1, wherein said output of said first sensor is approximately in phase with said output of said second sensor.

4. A system according to claim 1, wherein said codestrip comprises a discontinuity, said system being arranged to determining a position relative to said codestrip on a first side of the discontinuity from said output of said first sensor and arranged to determine a position relative to said codestrip on a second side of said discontinuity from said output of said second sensor.

5. A system according to claim 1, wherein said first and second sensors are mounted on respective supporting means, said supporting means being interconnected by said differential screw, said differential screw being rotatable to adjust the separation between said first and said second supporting means.

6. A system according to claim 5, wherein said respective supporting elements form part of a substantially unitary jig.

7. A system according to claim 5, wherein said sensors are optical sensors arranged to detect optical properties of said codestrip.

8. A system according to claim 5, wherein said sensors are magnetic sensors arranged to detect magnetic properties of said codestrip.

9. A system according to claim 1, wherein said codestrip graduations are substantially equi-spaced.

10. A system according to claim 9, wherein said codestrip graduations are arranged substantially perpendicular said first direction, said first direction lying substantially along the length of said codestrip.

11. A system according to claim 1, further comprising a further one or more sensors, the separation between said first or second sensors and each of said further one or more sensors being adjustable substantially in the first direction in order to bring the outputs of said further one or more sensors into a predetermined phase relationship with said output of said first or second sensors.

12. A system according to claim 1, wherein said outputs of the first and second sensors are adjustable to be substantially phase-equispaced.

13. A printer device comprising a print head arranged to move along a scan axis traversing a print zone, said printer having a sensor system according to any preceding claim arranged to determine the position of said print head relative to said scan axis.

14. An optical scanner comprising an optical head arranged to move along a scan axis, said optical scanner having a sensor system according to any one of claims 1 to 12 arranged to determine the position of said optical head relative to said scan axis.

15. A sensor system for determining a position relative to a codestrip, said codestrip comprising a plurality of graduations spaced apart in a first direction, said system comprising first and second sensors arranged to move substantially in said first direction relative to said graduations and to output signals corresponding to the detection of said graduations, said first sensor being movable relative to the second sensor substantially in said first direction such that the separation between said first and second sensors in said first direction may be adjusted to equal a distance substantially equal to an integer number of the codestrip graduation spacing plus a preselected fraction of said graduation spacing.

16. A sensor system for determining a position relative to a codestrip comprising a plurality of graduations spaced apart in a first direction and comprising a discontinuity between first and second sets of said graduations, said system comprising first and second sensors arranged to move in said first direction relative to said graduations and to detect said graduations, the spacing between said first and second sensors being adjustable such that signals output by said first and second sensors corresponding to the detection of graduations belonging to said first and second sets respectively may be brought into a predetermined phase relationship.

17. A jig for supporting a position sensor system for use with an position encoder strip or the like, comprising first and second mounting structures being arranged to respectively support first and second sensors, said first and second mounting structures being interconnected by a differential screw, such that the distance between said first and second mounting structures is adjustable in dependence upon the rotational position of the differential screw.

18. A method of calibrating a codestrip position measurement device, said device arranged to detect a series graduations substantially equi-spaced in a first direction, the device comprising first and second sensors arranged to detect said graduations, said method comprising the steps of:
moving said first and second sensors relative to said codestrip substantially in the first direction and detecting the signals output by the first and second sensors;
adjusting the spacing between the first and second sensors substantially in the first direction in order to bring the outputs of the first and second sensors into a predetermined phase relationship.

19. A method according to claim 18, wherein said signals output by said first and second sensors comprise high and low outputs, further comprising the step of carrying out a logical XOR between said signals output by said first and second sensors.

20. A method according to claim 18 or 19, further comprising the step of comparing the phase relationship between said signals of first and second sensors prior to the step of adjusting.

21. A method according to any one of claims 20, further comprising the step of calculating the phase change required in the signal output by either said first or second sensors in order to bring the outputs of said first and second sensors into said predetermined phase relationship.

22. A method according to any one of claims 18 to 21, further comprising the step of displaying the required phase change on a display.

23. A computer program comprising program code means for performing the method steps of any one of claims 18 to 22 when said program is run on a computer and/or other processing means associated with suitable apparatus.

24. A computer program product comprising program code means for performing the method steps of any one of claims 18 to 22 when the program is run on a computer and/or other processing means associated with suitable apparatus.
